(19) United States
(12) Patent Application Publication
(10) Pub. No.: US 2017/0187731 A1
(43) Pub. Date: Jun. 29, 2017

(54) INFORMATION PROCESSING SYSTEM, INFORMATION PROCESSING METHOD AND PROGRAM

(71) Applicant: LAC CO., LTD., Tokyo (JP)

(72) Inventor: Junichi HATTA, Tokyo (JP)

(73) Assignee: LAC CO., LTD., Tokyo (JP)

(21) Appl. No.: 15/456,860

(22) Filed: Mar. 13, 2017

Related U.S. Application Data
(63) Continuation-in-part of application No. PCT/JP2016/051727, filed on Jan. 21, 2016.

(30) Foreign Application Priority Data
Jan. 27, 2015 (JP) 2015-013747

(51) Int. Cl. H04L 29/06; H04L 29/12

(52) U.S. Cl. CPC H04L 63/1416; H04L 63/145; H04L 61/35; H04L 61/3015

(57) ABSTRACT

An information processing system includes a domain acquisitor configured to acquire a domain that is a connection destination of communication detected on a monitoring target network, a related information acquisitor configured to acquire related information which is information registered in association with the domain acquired by the domain acquisitor from a domain management device which holds information of domains that are registered, a storage configured to store a domain which is a connection destination satisfying at least a condition and related information of the domain.

### BACKGROUND

Technical Fields

Embodiments of the present invention generally relate to an information processing system, an information processing method, and a program.

Related Art

In recent years, malware which is a representative of computer viruses has become advanced and sophisticated in both of invasion methods and attack methods, and thus it is difficult to prevent damage by the malware in advance or to localize the damage by the malware. In a case of conventional malware, a relationship between an attack and damage by the malware can be easily inferred, and even though there are differences in the degree of difficulty in coping with the malware, the malware can be found relatively early. However, in a case of current malware, it is hard to notice an invasion of the malware, and great damage may occur before the malware is found. In the related art, for example, a method of inspecting a domain which is a destination of communication by the malware has been used to detect such advanced and sophisticated malware.

In addition, as a technology for detecting illegality using a domain, Japanese Unexamined Patent Application, First Publication No. 2014-64235 discloses a detection device which learns a transfer path as a domain path for each creator domain of an e-mail, and determines that the determination target mail is likely to be a spam mail when a transfer path of a determination target mail does not match a domain path of a creator domain of the determination target.

In the method described above, when malware is detected by inspecting a communication destination domain, it is necessary to ascertain a domain which is unauthorized in advance. However, an attacker may register a new domain to perform an attack by malware, and it is difficult to detect malware with a newly registered domain. In addition, the technology of Japanese Unexamined Patent Application, First Publication No. 2014-64235 does not detect such an attack by malware.

### SUMMARY

In some embodiments, an information processing system may include, but is not limited to, a domain acquisitor, a related information acquisitor, and an acquisitor. The domain acquisitor may be configured to acquire a domain of a connection destination of a communication detected on a monitoring target network. The related information acquisitor may be configured to acquire a related information from a domain management device. The related information is registered in association with the domain acquired by the domain acquisitor. The domain management device is configured to manage domains that are registered in the domain management device. The acquisitor may be configured to acquire, from the domain management device, a domain and a related information which is related to the domain. The related information acquired from the domain management device is identical at least in part to a related information which is related to a domain stored in a storage. The domain stored in the storage satisfies at least a condition. In some cases, the condition can be set by a user and can be changed by a user or by using software.

Further features and aspects of the present disclosure will become apparent from the following detailed description of exemplary embodiments with reference to the attached drawings.

### BRIEF DESCRIPTION OF THE DRAWINGS

FIG. 1 is a diagram which shows an overall configuration example of a computer system to which the present embodiment is applied.

FIG. 2 is a block diagram which shows a function configuration example of an attack detection device according to the embodiment.

FIG. 3 is a diagram which shows an example of a hardware configuration of a computer suitable for applying an attack detection device.

FIG. 4 is a flowchart which shows an example of a processing procedure for registering information in an attacker DB.

FIG. 5 is a diagram which shows an example of information registered in a domain information management server.

FIG. 6A is a diagram which shows an example of a list of domain names registered in the attacker DB.

FIG. 6B is a diagram which shows an example of a list of domain related information registered in the attacker DB.

FIG. 7A is a diagram which describes a specific example of processing by the attack detection device.

FIG. 7B is a diagram which describes a specific example of the processing by the attack detection device.

FIG. 7C is a diagram which describes a specific example of the processing by the attack detection device.

FIG. 7D is a diagram which describes a specific example of the processing by the attack detection device.

FIG. 8 is a flowchart which shows an example of a processing procedure in which information on another domain is added to the attacker DB based on information on an unauthorized domain.

### DETAILED DESCRIPTION OF THE EMBODIMENTS

In some embodiments, an information processing system may include, but is not limited to, a domain acquisitor, a related information acquisitor, an acquisitor, and a detector. The domain acquisitor may be configured to acquire a domain of a connection destination of a communication detected on a monitoring target network. The related information acquisitor may be configured to acquire a related information from a domain management device. The related information is registered in association with the domain acquired by the domain acquisitor. The domain management device is configured to manage domains that are registered in the domain management device. The acquisitor may be configured to acquire, from the domain management device, a domain and a related information which is related to the domain. The related information acquired from the domain management device is identical at least in part to a related information which is related to a domain stored in a storage. The domain stored in the storage satisfies at least a condition. In some cases, the condition can be set by a user and can be changed by a user or by using software.

In some cases, the information processing system may further include, but is not limited to, a detector configured to determine the communication detected on the monitoring target network as a communication with a domain which satisfies the at least condition, in cases that the related information acquired by the acquisitor from the domain management device is not a related information related to the domain of the connection destination of the communication detected on the monitoring target network and that the related information acquired by the acquisitor from the domain management device is identical at least in part to the related information acquired by the related information acquisitor from the domain management device.

In some cases, the information processing system may further include but is not limited to, a registration unit configured to register information not stored in the storage among the related information acquired by the related information acquisitor in the storage as domain information satisfying the at least condition.

In some cases, the information processing system may further include but is not limited to, a domain information acquisitor and a domain information registration unit. The domain information acquisitor may be configured to acquire domain information registered in association with the same information as at least one piece of the related information acquired by the related information acquisitor from the domain management device when the communication satisfies the at least condition. The domain information registration unit may be configured to register the domain information acquired by the domain information acquisitor in the storage as domain information satisfying the at least condition.

In some cases, the information processing system may further include but is not limited to, a receiver and an additional domain registration unit. The receiver may be configured to receive a notification that information held by the domain management device has been updated. The additional domain registration unit may be configured to, when it is ascertained that a new domain has been added to the domain management device in association with the same information as at least one piece of the related information stored in the storage by the notification received by the receiver, register information on the added domain in the storage.

In some embodiments, an information processing system may include, but is not limited to, a storage, a domain information acquisitor, and a registration unit. The storage stores domains registered and satisfying at least a condition, and related information registered in association with the domains. The domain information acquisitor may be configured to acquire, from a domain management device, domain information registered in association with a related information being identical at least in part to the related information stored in the storage, the domain management device being configured to manage domains registered. The registration unit may be configured to register, in the storage, the domain information acquired by the domain information acquisitor as domain information satisfying the at least condition, regardless of whether or not the domain information is a domain information of a connection destination of a communication detected on a monitoring target network.

In some cases, the domain information acquisitor further acquires information on another domain registered in association with the same information as at least one piece of the related information included in the domain information, registered in the storage by the registration unit, from the domain management device. The registration unit registers the information on the other domain acquired by the domain information acquisitor in the storage as information satisfying the at least condition.

In some cases, the registration unit registers the domain information acquired by the domain information acquisitor by distinguishing the information from information already stored in the storage.

In some cases, the registration unit registers the domain information acquired by the domain information acquisitor by distinguishing the information from information already stored in the storage.

In some embodiments, an information processing method may include, but is not limited to, acquiring a domain of a connection destination of a communication detected on a monitoring target network; acquiring a related information from a domain management device, the related information being registered in association with the domain acquired, the domain management device being configured to manage domains that are registered in the domain management device; acquiring, from the domain management device, a domain and a related information which is related to the domain, the related information acquired from the domain management device being identical at least in part to a related information which is related to a domain stored in a storage, the domain stored in the storage satisfying at least a condition, and determining the communication detected on the monitoring target network as a communication with a domain which satisfies the at least condition, in cases that the related information acquired from the domain management device is not a related information related to the domain of the connection destination of the communication detected on the monitoring target network and that the related information acquired from the domain management device is identical at least in part to the related information acquired from the domain management device.

In some embodiments, an information processing method may include, but is not limited to, acquiring, from a domain management device, domain information registered and satisfying at least a condition in association with a related information being identical at least in part to the related information stored in the storage, the domain management device being configured to manage domains registered; and registering, in the storage, the domain information acquired by the domain information acquisitor as domain information satisfying the at least condition, regardless of whether or not the domain information is a domain information of a connection destination of a communication detected on a monitoring target network.

In some embodiments, a non-transitory computer-readable storage medium stores a computer program, when executed by a computer, to cause the computer to perform at least: acquiring a domain of a connection destination of a communication detected on a monitoring target network; acquiring a related information from a domain management device, the related information being registered in association with the domain acquired, the domain management device being configured to manage domains that are registered in the domain management device; acquiring, from the domain management device, a domain and a related information which is related to the domain, the related information acquired from the domain management device being identical at least in part to a related information which is related to a domain stored in a storage, the domain stored in the storage satisfying at least a condition; and determining the communication detected on the monitoring target network as a communication with a domain which satisfies the at least condition, in cases that the related information acquired from the domain management device is not a related information related to the domain of the connection destination of the communication detected on the monitoring target network and that the related information acquired from the domain management device is identical at least in part to the related information acquired from the domain management device.

In some embodiments, a non-transitory computer-readable storage medium stores a computer program, when executed by a computer, to cause the computer to perform at least: acquiring, from a domain management device, domain information registered and satisfying at least a condition in association with a related information being identical at least in part to the related information stored in the storage, the domain management device being configured to manage domains registered; and registering, in the storage, the domain information acquired by the domain information acquisitor as domain information satisfying the at least condition, regardless of whether or not the domain information is a domain information of a connection destination of a communication detected on a monitoring target network.

Hereinafter, embodiments of the present invention will be described with reference to attached drawings.

<System Configuration>

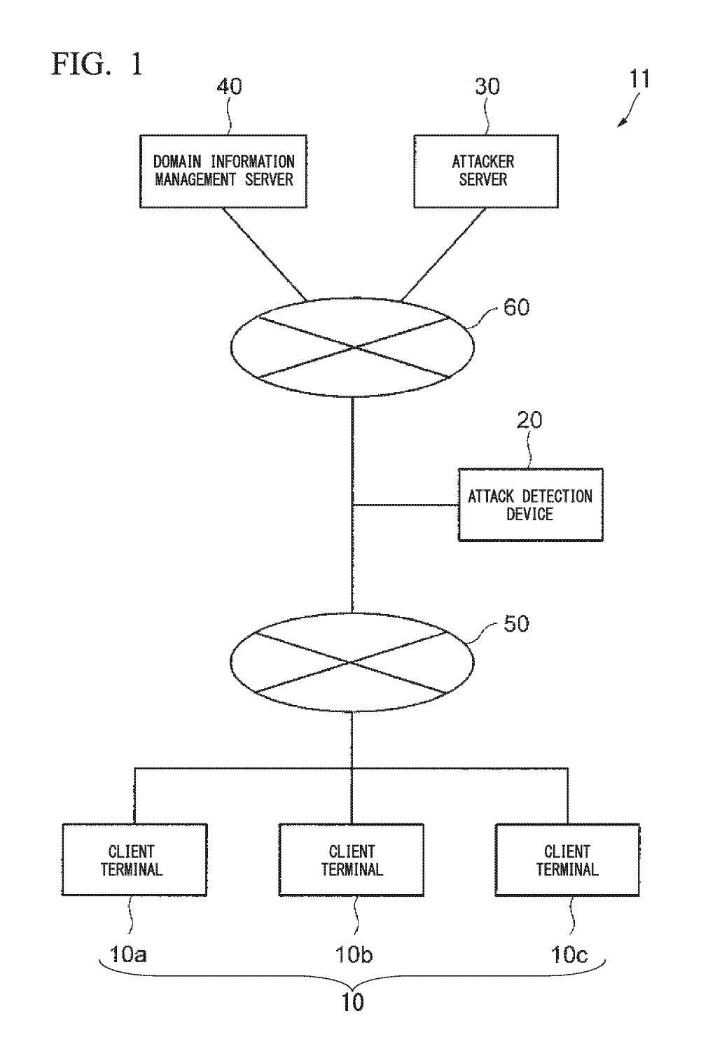

First, a computer system to which the present embodiment is applied will be described. FIG. 1 is a diagram which shows an overall configuration example of a computer system 11 to which the present embodiment is applied. As shown in FIG. 1, in the computer system 11, client terminals 10a, 10b, and 10c are connected to an in-house local area network (LAN) 50. In addition, an attack detection device 20 is connected to both of the in-house LAN 50 and the Internet 60. Furthermore, an attacker server 30 and a domain information management server 40 are connected to the Internet 60.

The client terminals 10a. 10b, and 10c are computers used by users, and are realized in, for example, personal computers, workstations, or other computer devices. In addition, in the present embodiment, the client terminals 10a, 10b, and 10c are set to be infected with malware. Here, malware is a generic term for malicious software or malicious codes which are created with an intention to perform an unauthorized and harmful operation. For example, a bot which is a type of malware, after infecting a computer, is connected to a control server referred to as a command and control (C&C) server and waits for an instruction from an attacker to execute processing according to an instruction on the infected computer.

In FIG. 1, the client terminals 10a, 10b, and 10c are shown, but, if there is no need to distinguish among them, the client terminals are sometimes referred to as client terminals 10. Moreover, only three client terminals 10 are shown in FIG. 1, but the number of the client terminals 10 is not limited to three as shown in FIG. 1.

The attack detection device 20 is a device which sets a network between the in-house LAN 50 and the Internet 60 as a monitoring target, and detects unauthorized communication highly likely to be an attack on the basis of domain information which is a connection destination of communication (transmission destination) detected on a monitoring target network. Here, the attack detection device 20 detects unauthorized communication with respect to, for example, a communication log stored in a proxy server (not shown) installed so as to be gone through when communication accesses the Internet 60 from the client terminal 10 via the in-house LAN 50, as communication detected on a network. In addition, the attack detection device 20 detects unauthorized communication with respect to, for example, traffic flowing on a current network in some cases. The attack detection device 20 may be provided in a communication device such as a gateway, or may be provided independently from the communication device.

Moreover, in FIG. 1, the attack detection device 20 is not installed in-line on a communication line between the in-house LAN 50 and the Internet 60, and is configured to acquire a communication log from, for example, the proxy server and the like. As another example, the attack detection device 20 may be configured to be installed in-line.

In the embodiment, the attack detection device 20 is used as one example of the information processing system. In the embodiment, a method of processing performed by the attack detection device 20 is used as an example of an information processing method.

The attacker server 30 is a server which is set as a connection destination of communication by the client terminal 10 infected with malware, and is operated by an attacker. The attacker server 30 corresponds to a control server of the connection destination to which the client terminal 10 is connected to wait for an instruction from the attacker, for example, when the client terminal 10 is infected with a bot. In addition, only one attacker server 30 is shown in FIG. 1, but there may be two or more attacker servers 30.

The domain information management server 40 is a server which manages information of domains registered for use on the Internet 60, and is, for example, a server of WHOIS which is an information providing service for providing domain information on the Internet 60. In the domain information management server 40, a domain name for specifying a domain registered on the Internet 60 and information registered in association with registering the domain (domain name) are stored. As the information registered in association with registering a domain, there is, for example, information on a registrant who has registered a domain and the like. In the following, the information registered in association with registering a domain is referred to as domain related information. In the embodiment, as an example of the related information, the domain related information is used. Furthermore, in the embodiment, the domain information management server 40 is used as an example of a domain management device.

The in-house LAN 50 is a network which connects computers and printers in a company and allows data to be transmitted and received among them.

The Internet 60 is a huge network which connects worldwide networks to each other using transmission control protocol/internet protocol (TCP/IP).

In the embodiment, when the client terminal 10 is infected with malware, the client terminal 10 is connected to an unauthorized server such as the attacker server 30 and performs processing. Therefore, the attack detection device 20 stores a domain which is a connection destination for connecting to the unauthorized server such as the attacker server 30 and domain related information of the domain in advance. Then, the attack detection device 20 sets a network between the in-house LAN 50 and the Internet 60 as a monitoring target, and if communication detected on the monitoring target network matches domain information which is a connection destination or the domain related information of the domain, the attack detection device 20 detects the communication as unauthorized communication. Furthermore, the attack detection device 20 newly stores a domain of the detected unauthorized communication and domain related information of the domain as unauthorized domain information.

<Functional Configuration of Attack Detection Device>

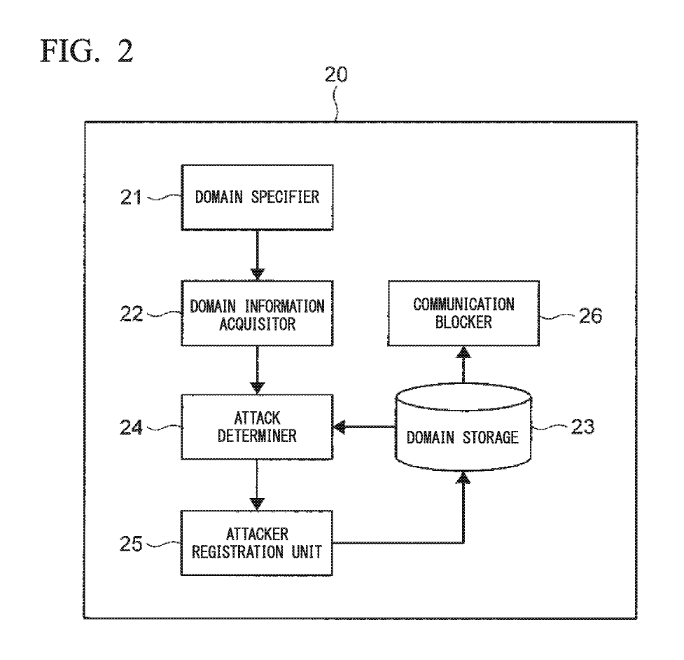

Next, a functional configuration of the attack detection device 20 will be described. FIG. 2 is a block diagram which shows a functional configuration example of the attack detection device 20 according to the embodiment.

A shown in FIG. 2, the attack detection device 20 includes a domain specifier 21 configured to specify a domain which is a connection destination of communication detected on a network between the in-house LAN 50 (refer to FIG. 1) and the Internet 60 (refer to FIG. 1), a domain information acquisitor 22 configured to acquire domain related information of the specified domain from the domain information management server 40 (refer to FIG. 1), and a domain storage 23 configured to store information on an unauthorized domain which is regarded as an attacker. In addition, the attack detection device 20 includes an attack determiner 24 configured to determine whether processing target communication is unauthorized communication, an attacker registration unit 25 configured to newly register a domain of communication determined as unauthorized communication and domain related information of the domain, and a communication blocker 26 configured to block communication in which a domain stored in the domain storage 23 as an unauthorized domain is set as a connection destination.

The domain specifier 21 as an example of domain acquisition means (a domain acquisitor) sets a network between the in-house LAN 50 and the Internet 60 as a monitoring target and specifies a domain (domain name) which is a connection destination of communication detected on the monitoring target network. Here, the domain specifier 21, for example, with an operation of a user as a trigger, refers to a log stored in a proxy server (not shown) installed so as to be gone through when communication accesses the Internet 60 from the client terminal 10 via the in-house LAN 50, and specifies a processing target domain. In addition, for example, when domain name system (DNS) communication which requests an IP address to access a domain which is a connection destination from the client terminal 10 is performed, the domain specifier 21 specifies a domain on the basis of contents of data included in the communication.

The domain information acquisitor 22 as an example of related information acquisition means (a related information acquisitor) acquires domain related information stored in the domain information management server 40 for the domain specified by the domain specifier 21. The domain information management server 40 stores and holds the domain related information.

The domain storage 23 as an example of storage means (a storage) stores a database (hereinafter, referred to as an attacker DB) in which domain information which is set as an unauthorized connection destination by an attacker is registered. Information of the attacker DB is recorded by a user's registration of a domain name which is already known as an attacker and domain related information of the domain in advance. In addition, for a domain of unauthorized communication newly determined as an attack by the attack determiner 24, the attacker registration unit 25 registers a domain name or domain related information of the domain, and thereby the information of the attacker DB is recorded.

The attack determiner 24 which is an example of detection means (a detector) compares the domain specified by the domain specifier 21 and the domain related information acquired by the domain information acquisitor 22 with the information of the attacker DB stored in the domain storage 23, and determines whether processing target communication is unauthorized communication. Here, the attack determiner 24 determines that the processing target communication is unauthorized communication if the same domain as the domain specified by the domain specifier 21 is registered in the attacker DB. In addition, even when the same domain as the domain specified by the domain specifier 21 is not registered in the attacker DB, the attack determiner 24 determines that the processing target communication is unauthorized communication if the same information as at least one piece of the domain related information acquired by the domain information acquisitor 22 is registered in the attacker DB.

The attacker registration unit 25 which is an example of registration means (a registration unit), domain information acquisition means (a domain information acquisitor), and domain information registration means (a domain information registration unit) registers, for the communication determined as unauthorized communication by the attack determiner 24, a domain of the communication and domain related information of the domain in the attacker DB of the domain storage 23. Here, when an attack by the attack determiner 24 is determined, description is performed by separating a case in which a domain specified by the domain specifier 21 is not registered in the attacker DB and the domain related information acquired by the domain information acquisitor 22 is registered in the attacker DB from a case in which a domain specified by the domain specifier 21 is registered in the attacker DB.

In the case in which a domain specified by the domain specifier 21 is not registered in the attacker DB and at least one piece of the domain related information acquired by the domain information acquisitor 22 is registered in the attacker DB when the domain is determined as an attack, the attacker registration unit 25 registers the domain specified by the domain specifier 21 in the attacker DB as new attacker information. In addition, the attacker registration unit 25 registers information which is not registered in the attacker DB yet among the domain related information acquired by the domain information acquisitor 22 in the attacker DB as new attacker information. Furthermore, the attacker registration unit 25 accesses the domain information management server 40, and searches for a domain registered in association with the same information as at least one piece of the domain related information acquired by the domain information acquisitor 22. Then, if there is a domain registered in association with information the same as the domain related information acquired by the domain information acquisitor 22, the attacker registration unit 25 registers both the domain and the domain related information of the domain in the attacker DB.

That is, domain related information acquired by the domain information acquisitor 22 is registered in the domain information management server 40 as domain related information of a domain currently identified by the domain specifier 21, but there may be another domain registering the same information as the domain related information as domain related information. In this case, the attacker registration unit 25 also registers the other domain and the domain related information in the attacker DB as attacker information. In addition, when there is a plurality of pieces of domain related information of the domain specified by the domain specifier 21, if there is a domain registering the same information as at least one piece of the domain related information as domain related information, the attacker registration unit 25 registers information related to the domain in the attacker DB.

On the other hand, in the case in which a domain specified by the domain specifier 21 is registered in the attacker DB when the domain is determined as an attack, the domain related information of the domain is also already registered in the attacker DB, and the attacker registration unit 25 does not newly register information in the attacker DB. However, for example, when a user registers only a domain in the attacker DB in advance and the like, the domain related information is not registered. Therefore, even when a domain specified by the domain specifier 21 is registered in the attacker DB, if domain related information acquired by the domain information acquisitor 22 with respect to the domain is not registered in the attacker DB, the attacker registration unit 25 may register the domain related information in the attacker DB. In this case, the attacker registration unit 25 further accesses the domain information management server 40, and if there is a domain registered in association with the same information as at least one piece of the domain related information acquired by the domain information acquisitor 22, the attacker registration unit 25 may register both the domain and the domain related information of the domain in the attacker DB.

The communication blocker 26 performs a control so as to block communication performed on a network between the in-house LAN 50 (refer to FIG. 1) and the Internet 60 (refer to FIG. 1) on the basis of domain information stored in the domain storage 23. That is, the communication blocker 26 monitors communication performed on a network and, if a domain which is a connection destination of communication is registered in the attacker DB, the communication blocker performs processing to block the communication on the basis of the attacker DB frequently updated by the attacker registration unit 25. In addition, the communication blocker 26 acquires, for example, domain related information of the domain which is a connection destination of communication during the monitoring from the domain information management server 40, and blocks the communication if the acquired domain related information is registered in the attacker DB.

The blocked communication is controlled such that it does not go through, for example, the proxy server to the Internet 60. In addition, the communication blocker 26 may also generate an alert which notifies that the communication is unauthorized communication instead of blocking communication or with blocking of the communication. The alert is displayed on a display screen of the attack detection device 20 to be notified to a user.

<Hardware Configuration Example of Attack Detection Device>

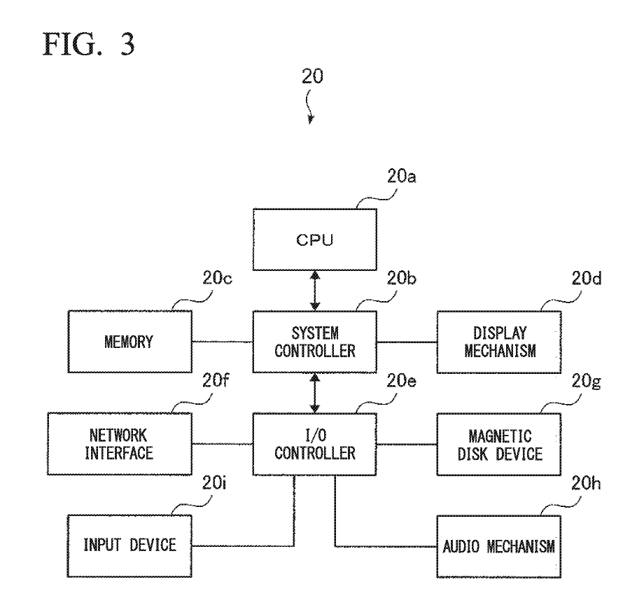

Next, a hardware configuration of the attack detection device 20 according to the present embodiment will be described. FIG. 3 is a diagram which shows an example of a hardware configuration of a computer suitable for applying an attack detection device. As shown in FIG. 3, the attack detection device 20 includes a central processing unit (CPU) 20a which is arithmetic operation means (an arithmetic operation unit), and a memory 20c which is main storage means (a main storage). The attack detection device 20 includes, as external devices, a magnetic disk device (hard disk drive (HDD)) 20g, a network interface 20f, a display mechanism 20d including a display device, an audio mechanism 20h, an input device 20i such as a keyboard or a mouse, and the like. Moreover, the attack detection device 20 includes a system controller 20b and an I/O controller 20e.

In a configuration shown in FIG. 3, the memory 20c and the display mechanism 20d are connected to the CPU 20a via the system controller 20b. In addition, the network interface 20f, the magnetic disk device 20g, the audio mechanism 20h, and the input device 20i are connected to the system controller 20b via the I/O controller 20e. Respective configuration elements are connected to each other by various types of bus such as a system bus and an input/output bus.

In addition, an OS program and an application program are saved in the magnetic disk device 20g in FIG. 3. Then, these programs are loaded into the memory 20c and executed by the CPU 20a, and thereby functions of the domain specifier 21, the domain information acquisitor 22, the attack determiner 24, the attacker registration unit 25, and the communication blocker 26 in the attack detection device 20 according to the embodiment are realized. In addition, the domain storage 23 is realized by storage means (a storage) such as the magnetic disk device 20g.

FIG. 3 only illustrates a hardware configuration of a computer suitable for applying the present embodiment. The embodiment can be widely applied to an apparatus that detects unauthorized communication. The embodiment is not realized only in the configuration shown in FIG. 3. That is, a configuration for realizing the embodiment is not limited to the configuration shown in FIG. 3.

<Processing Procedure of Attack Detection Device>

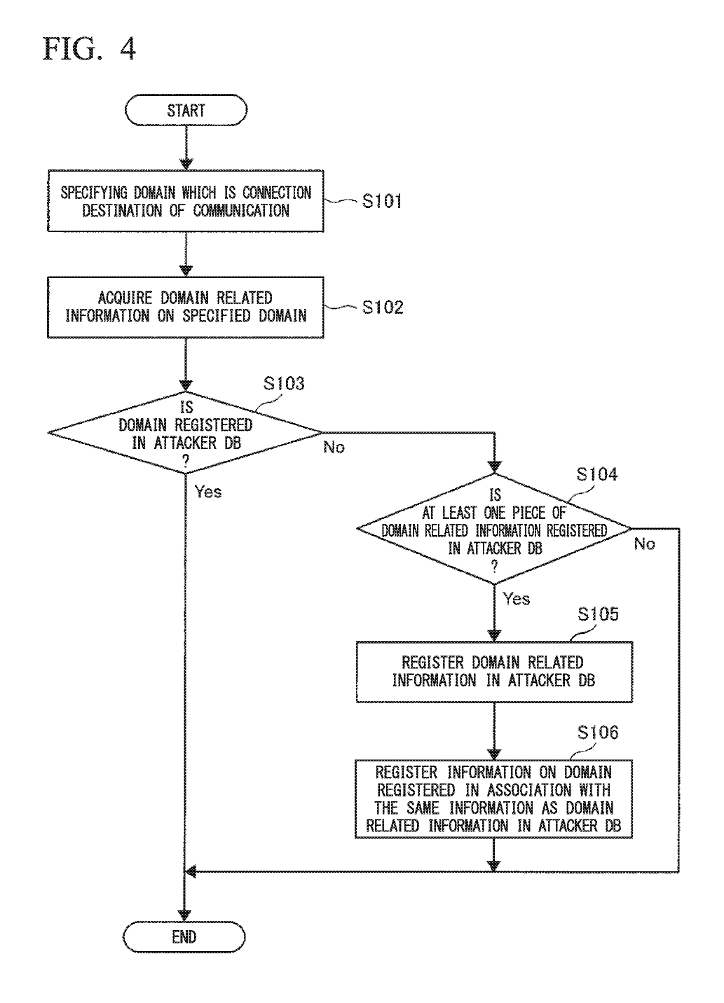

Next, a procedure of processing in which the attack detection device 20 registers information in the attacker DB will be described. FIG. 4 is a flowchart which shows an example of the processing procedure in which the attack detection device 20 registers information in the attacker DB. The processing shown in FIG. 4 is executed for each communication detected on a monitoring target network by the attack detection device 20.

First, the domain specifier 21 acquires a log from, for example, a proxy server, with respect to communication between the in-house LAN 50 and the Internet 60, thereby specifying a domain which is a connection destination of the communication (step 101). Next, the domain information acquisitor 22 acquires domain related information stored in the domain information management server 40 with respect to the specified domain (step 102).

Next, the attack determiner 24 determines whether the same domain as the domain specified in step 101 is registered in the attacker DB of the domain storage 23 (step 103). When it is determined that the domain is registered in the attacker DB (YES in step 103), the attack determiner 24 determines that processing target communication is unauthorized communication by an attack. Here, even if the domain is registered in the attacker DB, when domain related information of the domain is not registered in the attacker DB, the attacker registration unit 25 may register the domain related information in the attacker DB. In addition, the attacker registration unit 25 accesses the domain information management server 40, and may further register a domain registered in association with the same information as the domain related information acquired by the domain information acquisitor 22 in step 102 and domain related information of the domain in the attacker DB. Then, the processing flow ends.

In addition, in step 103, when it is determined that the same domain as the domain specified in step 101 is not registered in the attacker DB (NO in step 103), the attack determiner 24 determines whether the same information as at least one piece of the domain related information acquired in step 102 is registered in the attacker DB (step 104). When it is determined that the information is not registered in the attacker DB (NO in step 104), the processing flow ends.

On the other hand, in step 104, when it is determined that the information is registered in the attacker DB (Yes in step 104), the attacker registration unit 25 registers information which is not registered in the attacker DB yet among the domain related information acquired by the domain information acquisitor 22 in step 102 in the attacker DB (step 105). Here, the attacker registration unit 25 registers the domain specified by the domain specifier 21 in the attacker DB. In addition, the attacker registration unit 25 accesses the domain information management server 40, and may further register a domain registered in association with the same information as at least one piece of the domain related information acquired in step 102 and domain related information of the domain in the attacker DB (step 106). Then, the processing flow ends.

Moreover, in the procedure shown in FIG. 4, the attacker registration unit 25 registers a domain registered in association with the same information as the domain related information acquired by the domain information acquisitor 22 in step 102 and domain related information in the attacker DB in step 106 and the processing ends, but the embodiment is not limited to such a configuration. The attacker registration unit 25 may be configured to further access the domain information management server 40 and to register information on a new attacker in the attacker DB on the basis of the information registered in the attacker DB in step 106.

For example, if there is a domain registered in association with the same information as at least one piece of the domain related information registered in the attacker DB in step 106, the attacker registration unit 25 may further register the domain and domain related information of the domain in the attacker DB. In this manner, the attacker registration unit 25 may be configured to search for whether the domain correlated with the information newly registered in the attacker DB is stored in the domain information management server 40, and to repeatedly execute processing of searching for information of the domain information management server 40 and registering it in the attacker DB until, for example, all the information obtained by the searching is completely registered in the attacker DB.

<Information Registered in a Domain Information Management Server>

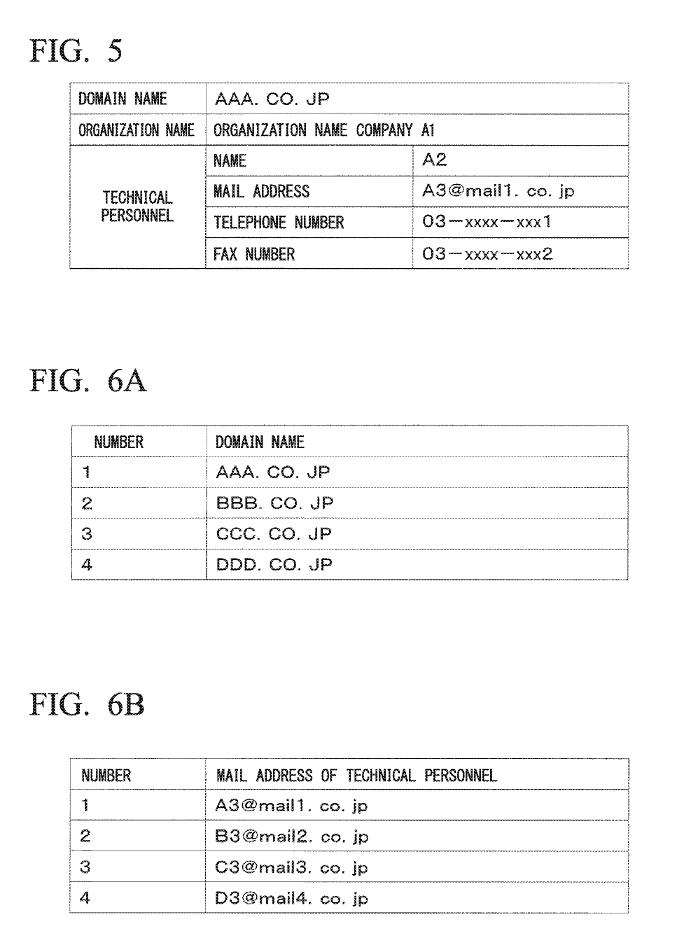

Next, information registered in the domain information management server 40 will be described. FIG. 5 is a diagram which shows an example of the information registered in the domain information management server 40.

In an example shown in FIG. 5, with regard to a domain named “AAA.CO.JP”, as domain related information of the domain, an organization name of a registrant who registers the domain, and a name, a mail address, a telephone number, and a fax number of technical personnel in the organization are registered. Specifically, the organization name is registered as “A2”, the mail address is registered as “A3@mail.co.jp”, the telephone number is registered as “03-xxxx-xxx1”, and the fax number is registered as “03-xxxx-xxx2”.

As described above, a domain name of domains registered for use in the Internet 60 and domain related information of the domain are registered in the domain information management server 40 for each domain. However, the domain related information is not limited to the type of information shown in FIG. 5.

<Information Registered in the Attack DB>

Next, information registered in the attacker DB of the domain storage 23 will be described. FIGS. 6A and 6B are diagrams which show examples of the information registered in the attacker DB. FIG. 6A is a diagram which shows an example of a list of domain names registered in the attacker DB. In addition, FIG. 6B is a diagram which shows an example of a list of domain related information registered in the attacker DB.

First, in an example shown in FIG. 6A four domains with domain names called “AAA.CO.JP”, “BBB.CO.JP”, “CCC.CO.JP”, and “DDD.CO.JP” are registered in the attacker DB as an attacker domain. For these domains, a user may register the domain in advance or the attacker registration unit 25 may register the domain as a domain of unauthorized communication which is newly determined as an attack.

In addition, in an example shown in FIG. 6B, four mail addresses named “A3@mail1.co.jp”, “B3@mail2.co.jp”, “C3@mail3.co.jp”, and “D3@mail4.co.jp” are registered in the attacker DB as domain related information of an attacker domain. These mail addresses are mail addresses of technical personnel in an organization of a registrant who registers the attacker domains, and correspond to the mail address shown in FIG. 5. For these pieces of domain related information, in the same manner as the domain shown in FIG. 6A, a user may register the domain related information in advance or the attacker registration unit 25 may register the domain related information as domain related information of a domain of unauthorized communication newly determined as an attack.

In addition, in an example shown in FIG. 6B, the mail addresses of technical personnel are shown as domain related information registered in the attacker DB, but other domain related information may be configured to be registered in the attacker DB. For example, as shown in FIG. 5, in addition to the mail address of technical personnel, an organization name, a name, a telephone number, and a fax number of the technical personnel are registered as domain related information in the domain information management server 40. For this reason, these pieces of domain related information may be configured to be registered in the attacker DB as information for detecting communication by an attacker.

Furthermore, in examples shown in FIGS. 6A and 6B, cases in which domains and mail addresses are collected as a list, respectively, and registered as the information registered in the attacker DB are described, but the embodiment is not limited to such a configuration. As shown in FIG. 5, even in the attacker DB, a domain name and domain related information of the domain may be configured to be registered for each domain.

<Specific Example of the Processing by the Attack Detection Device>

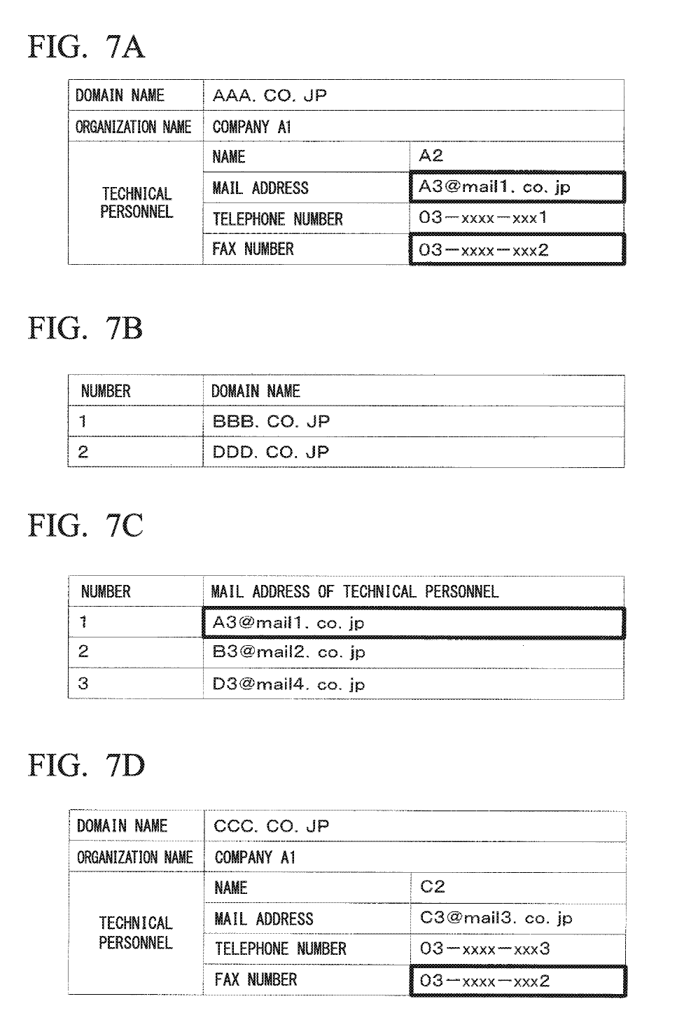

Next, the processing by the attack detection device 20 will be described in a specific example. FIGS. 7A, 7B, 7C, and 7D are diagrams which describe a specific example of the processing by the attack detection device 20. Examples shown in FIGS. 7A, 7B, 7C, and 7D are examples of a case in which the processing target communication is determined as an attack and domain related information acquired by the domain information acquisitor 22 is registered in the attacker DB. Steps shown hereinafter correspond to respective steps of FIG. 4.

In examples shown in FIGS. 7A, 7B, 7C, and 7D, the domain specifier 21 specifies a domain named “AAA.CO.JP” as a domain which is a connection destination of processing target communication (step 101). Next, the domain information acquisitor 22 acquires domain related information of the domain of “AAA.CO.JP” from the domain information management server 40 (step 102). Here, FIG. 7A shows an example of information on “AAA.CO.JP” registered in the domain information management server 40.

Next, the attack determiner 24 determines whether “AAA. CO. JP” is registered in the attacker DB (step S103). FIGS. 7B and 7C are diagrams which show examples of the information registered in the attacker DB. FIG. 7B shows the domain name registered in the attacker DB. In addition, FIG. 7C shows the mail address of technical personnel which is one type of the domain related information registered in the attacker DB. Here, as shown in FIG. 7B, the domain named “AAA.CO.JP” is not registered in the attacker DB. For this reason, the attack determiner 24 determines that the domain is not registered in the attacker DB (NO in step 103). Next, the attack determiner 24 determines whether at least one piece of the domain related information of “AAA.CO.JP” is registered in the attacker DB (step 104).

Here, as shown in FIG. 7A, the mail address of technical personnel which is the domain related information of “AAA.CO.JP” is “A3@mail1.co.jp” enclosed by a thick frame. In addition, the mail address of “A3@mail1.co.jp” enclosed by a thick frame is also registered in the attacker DB. Therefore, the attack determiner 24 determines that the domain related information is registered in the attacker DB (YES in step 104) and processing target communication is unauthorized communication by an attack.

Next, the attacker registration unit 25 registers the domain related information of the domain of “AAA.CO.JP” determined as unauthorized communication in the attacker DB (step 105). That is, the attacker registration unit 25 registers the domain related information shown in FIG. 7A in the attacker DB. In addition, as shown in FIG. 7B, since the domain of “AAA.CO.JP” is not registered in the attacker DB, the attacker registration unit 25 registers “AAA.CO.JP” in the attacker DB.

Next, the attacker registration unit 25 accesses the domain information management server 40 and searches for a domain registered in association with the same information as the domain related information of “AAA.CO.JP” registered in the attacker DB. Here, for a domain named “CCC.CO.JP” shown in FIG. 7D, a fax number of technical personnel is “03-xxxx-xxx2”, enclosed by a thick frame. In addition, a fax number of technical personnel of the domain of “AAA.CO.JP” is also “03-xxxx-xxx2” enclosed by a thick frame in FIG. 7A, and the fax number is to the same as the fax number of the domain of “CCC.CO.JP”.

For this reason, the attacker registration unit 25 determines that the domain named “CCC.CO.JP” registered in the domain information management server 40 is a domain registered in association with the same information as the domain related information of “AAA.CO.JP”. Then, the attacker registration unit 25 registers information on “CCC.CO.JP” shown in FIG. 7D, that is, the domain named “CCC.CO.JP” and the domain related information, in the attacker DB (step 106).

Moreover, in the examples shown in FIGS. 7A, 7B. 7C, and 7D, a domain correlated with the fax number of technical personnel of the domain of “AAA.CO.JP” is registered. However, if there is a domain correlated with other domain related information of “AAA.CO.JP” in the domain information management server 40, domain information will be also registered in the attacker DB in the same manner.

In the examples shown in FIGS. 7A, 7B, 7C, and 7D, the attacker registration unit 25 may further search for information of the domain information management server 40 on the basis of the domain related information of “CCC.CO.JP” registered in the attacker DB in step 106. Then, the attacker registration unit 25 may also register a domain registered in association with the same information as the domain related information of “CCC.CO.JP” and domain related information of the domain in the attacker DB. In addition, as subsequent processing, the attacker registration unit 25 may search for information of the domain information management server 40 based on domain related information newly registered in the attacker DB, and may repeatedly execute processing of registering in the attacker DB until, for example, all the information obtained by the searching is completely registered in the attacker DB.

As described above, the attack detection device 20 according to the embodiment specifics a domain which is a connection destination of communication detected on a monitoring target network, and acquires domain related information of the specified domain from the domain information management server 40. In addition, if the specified domain or the acquired domain related information is registered in the attacker DB, the attack detection device 20 detects communication which is a processing target as unauthorized communication. Therefore, by using the attack detection device 20, detection of unauthorized communication is performed on the basis of a domain and domain related information, and this makes detection of unauthorized communication easier than in, for example, a configuration in which unauthorized communication is detected on the basis of malware and the like by inspecting a domain.

Moreover, when the attack detection device 20 detects processing target communication as unauthorized communication, a domain of the detected unauthorized communication and domain related information are newly registered in the attacker DB and the information of the attacker DB is updated. Furthermore, the attack detection device 20 registers a domain registered in association with the same information as the domain related information of the detected unauthorized communication and domain related information of the domain in the attacker DB. Therefore, information on an unauthorized domain is added to the attacker DB and it becomes easy to detect processing target communication as unauthorized communication.

Here, in the present embodiment, when the attack detection device 20 detects the processing target communication as unauthorized communication, the attack detection device adds a domain and domain related information which are not registered yet to the attacker DB; however, the embodiment is not limited to such a configuration. For example, the attack detection device 20 may be configured to search for information of the domain information management server 40 on the basis of information on an unauthorized domain already registered in the attacker DB, and to add information on another domain in the attacker DB.

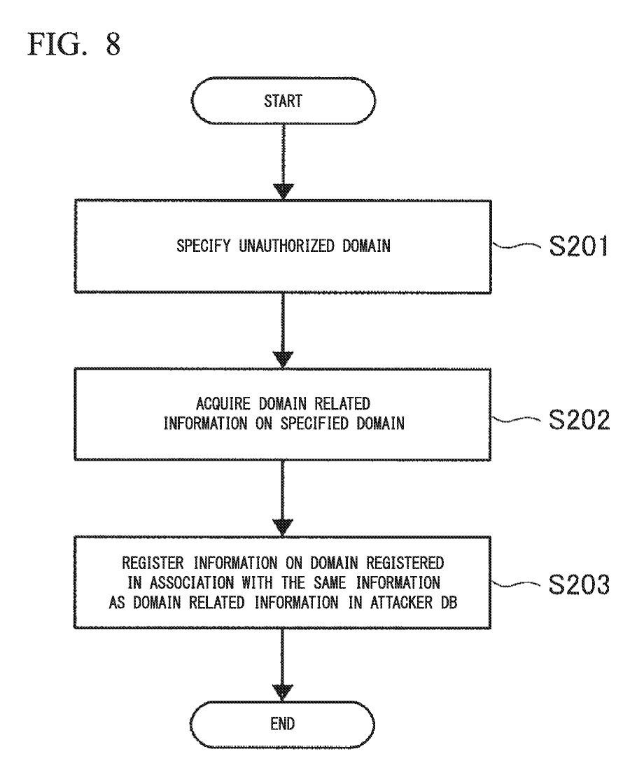

FIG. 8 is a flowchart which shows an example of a processing procedure in which information on another domain is added to the attacker DB on the basis of information on an unauthorized domain.

First, the domain specifier 21 specifies an unauthorized domain already registered in the attacker DB (step 201). Next, the domain information acquisitor 22 acquires domain related information of the domain specified by the domain specifier 21, which is stored in the domain information management server 40 (step 202). Here, if the domain related information is added to the attacker DB in addition to the domain as information on the unauthorized domain, the domain information acquisitor 22 does not have to acquire the domain related information from the domain information management server 40.

Next, the attacker registration unit 25 accesses the domain information management server 40, and further registers a domain registered in association with the same information as at least one piece of the domain related information and domain related information of the domain in the attacker DB (step 203). Moreover, the attacker registration unit 25 may be configured to, as subsequent processing, access the domain information management server 40, to search for a domain registered in association with the domain related information newly registered in the attacker DB, and to repeatedly execute processing of registering the domain and domain related information of the domain in the attacker DB. Then, the processing flow ends.

Moreover, in the present embodiment, if the attack detection device 20 can receive notification that the information of the domain information management server 40 has been updated, the attack detection device 20 may be configured to update the attacker DB on the basis of the notification. In this case, for example, the attacker registration unit 25 receives notification that a new domain has been registered in the domain information management server 40 in association with the same information as the domain related information registered in the attacker DB. In addition, for example, the attacker registration unit 25 extracts notification that a new domain has been registered in association with the same information as the domain related information registered in the attacker DB from the notification that the information of the domain information management server 40 has been updated.

Then, if the attacker registration unit 25 ascertains that a new domain has been registered in the domain information management server 40 in association with the same information as the domain related information registered in the attacker DB on the basis of the received notification, the attacker registration unit 25 accesses the domain information management server 40. Then, the attacker registration unit 25 acquires and registers a domain newly registered in the domain information management server 40 and domain related information of the domain in the attacker DB. In this case, the attacker registration unit 25 is used as an example of reception means (a receiver) and additional domain registration means (an additional domain registration unit).

Moreover, in the embodiment, among the information of the domain information management server 40, domain information registered in association with the same information as the domain related information of the attacker DB is registered in the attacker DB as domain information which is an unauthorized connection destination, but the embodiment is not limited to such a configuration. The domain information registered in association with the same information as the domain related information of the attacker DB may be configured not to be, for example, domain information which is an unauthorized connection destination, and to be distinguished from the information already registered in the attacker DB and newly registered by being handled as domain information equivalent to the domain which is an unauthorized connection destination. In other words, domain information which is regarded to be unauthorized is registered in the attacker DB in advance, but a domain newly added to the attacker DB on the basis of the domain information may be furthermore configured to be handled only as, for example, information inferred to be an unauthorized connection destination.

In this case, if a user registers a domain determined to be an unauthorized connection destination in the attacker DB in advance, and if there is a domain registered in association with the same information as domain related domain information in the domain information management server 40, the domain is distinguished from the domain registered in the attacker DB in advance and registered as a domain inferred to be an unauthorized connection destination. In addition, also when a further domain is added to the attacker DB on the basis of the domain estimated as an unauthorized connection destination, information on an original domain and domain information to be added may be configured to be distinguished from each other and registered.

For this reason, for example, a user can determine how information has been registered, such as whether a domain registered in the attacker DB is a domain determined as an unauthorized connection destination or a domain estimated as an unauthorized connection destination. In addition, for example, when communication on a network is detected as unauthorized communication, depending on whether a domain determined as an unauthorized connection destination is set as a connection destination, or a domain inferred to be an unauthorized connection destination is set as a connection destination, a content to be displayed may be configured to be changed and notified to the user.

Furthermore, in the embodiment, the domain storage 23 is configured to store domain information set as an unauthorized connection destination in the attacker DB, but may be configured to store domain information which is set not as an unauthorized connection destination but as a normal connection destination. When the domain storage 23 stores domain information set as a normal connection destination, the attack determiner 24 compares a domain specified by the domain specifier 21 and domain related information acquired by the domain information acquisitor 22 with the information stored in the domain storage 23, and determines whether processing target communication is normal communication. Moreover, the attack registration unit 25 registers, for communication determined as normal communication by the attack determiner 24, a domain of the communication and domain related information of the domain in the domain storage 23. With such a configuration, when a domain registered in the domain storage 23 is a normal domain and a domain and domain related information of the processing target communication are registered in the domain storage 23, the communication is detected as normal communication.

Here, whether the domain is an unauthorized connection destination or a normal connection destination is determined by whether at least a condition is satisfied. For example, when a certain domain satisfies at least a condition and is determined as a normal connection destination, the domain is stored in the domain storage 23 as a normal connection destination. In the embodiment, as an example of the domain satisfying the at least condition, a domain set as an unauthorized connection destination or a domain set as a normal connection destination are used.

The apparatus, systems and methods in the above-described embodiments may be deployed in part or in whole through machines, a system of circuits, circuitry, hardware processors that executes computer software, software components, program codes, and/or instructions on one or more machines, a system of circuits, circuitry, hardware processors. In some cases, the one or more machines, a system of circuits, circuitry, hardware processors may be part of a general-purpose computer, a server, a cloud server, a client, network infrastructure, mobile computing platform, stationary computing platform, or other computing platform. One or more processors may be any kind of computational or processing device or devices which are capable of executing program instructions, codes, binary instructions and the like. The one or more hardware processors may be or include a signal processor, digital processor, embedded processor, microprocessor or any variants such as a co-processor, for example, math co-processor, graphic co-processor, communication co-processor and the like that may directly or indirectly facilitate execution of program codes or program instructions stored thereon. In addition, the one or more hardware processors may enable execution of multiple programs, threads, and codes. The threads may be executed simultaneously to enhance the performance of the one or more hardware processors and to facilitate simultaneous operations of the application. Program codes, program instructions and the like described herein may be implemented in one or more threads. The one or more hardware processors may include memory that stores codes, instructions and programs as described herein. The machines, a system of circuits, circuitry, hardware processors may access a non-transitory processor-readable storage medium through an interface that may store codes, instructions and programs as described herein and elsewhere. The non-transitory processor-readable storage medium associated with the machines, a system of circuits, circuitry, hardware processors for storing programs, codes, program instructions or other type of instructions capable of being executed by the computing or processing device may include but may not be limited to one or more of a memory, hard disk, flash drive, RAM, ROM, CD-ROM, DVD, cache and the like.

A processor may include one or more cores that may enhance speed and performance of a multiprocessor. In some embodiments, the process may be a dual core processor, quad core processors, other chip-level multiprocessor and the like that combine two or more independent cores.

The methods, apparatus and systems described herein may be deployed in part or in whole through a machine that executes computer software on a server, client, firewall, gateway, hub, router, or other such computer and/or networking hardware.

The software program may be associated with one or more client that may include a file client, print client, domain client, internet client, intranet client and other variants such as secondary client, host client, distributed client and the like. The client may include one or more of memories, processors, computer readable media, storage media, physical and virtual ports, communication devices, and interfaces capable of accessing other clients, servers, machines, and devices through a wired or a wireless medium, and the like. The programs or codes as described herein may be executed by the client. In addition, other devices required for execution of methods as described in this application may be considered as a part of the infrastructure associated with the client. The client may provide an interface to other devices including servers, other clients, printers, database servers, print servers, file servers, communication servers, distributed servers and the like. This coupling and/or connection may facilitate remote execution of program across the network. The networking of some or all of these devices may facilitate parallel processing of a program or method at one or more location. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The software program may be associated with one or more servers that may include a file server, print server, domain server, internet server, intranet server and other variants such as secondary server, host server, distributed server and the like. The server may include one or more of memories, processors, computer readable media, storage media, physical and virtual ports, communication devices, and interfaces capable of accessing other servers, clients, machines, and devices through a wired or a wireless medium, and the like. The methods, programs or codes as described herein may be executed by the server. In addition, other devices required for execution of methods as described in this application may be considered as a part of the infrastructure associated with the server. The server may provide an interface to other devices including clients, other servers, printers, database servers, print servers, file servers, communication servers, distributed servers, social networks, and the like. This coupling and/or connection may facilitate remote execution of program across the network. The networking of some or all of these devices may facilitate parallel processing of a program or method at one or more locations. Any of the devices attached to the server through an interface may include at least one storage medium capable of storing programs, codes and/or instructions. A central repository may provide program instructions to be executed on different devices. In this implementation, the remote repository may act as a storage medium for program codes, instructions, and programs.

The methods, apparatus and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing devices associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD, removable media such as flash memory, for example, USB sticks or keys, floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The modules, engines, components, and elements described herein, including in flow charts and block diagrams throughout the figures, imply logical boundaries between the modules, engines, components, and elements. However, according to software or hardware engineering practices, the modules, engines, components, and elements and the functions thereof may be implemented on one or more processors, computers, machines through computer executable media, which are capable of executing program instructions stored thereon as a monolithic software structure, as standalone software modules, or as modules that employ external routines, codes, services, or any combination of these, and all such implementations may be within the scope of the present disclosure. Examples of such machines may include, but is not limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers, processor-embedded eyewear and the like. Furthermore, the modules, engines, components, and elements in the flow chart and block diagrams or any other logical component may be implemented on one or more machines, computers or processors capable of executing program instructions. Whereas the foregoing descriptions and drawings to which the descriptions have been referred set forth some functional aspects of the disclosed systems, no particular arrangement of software for implementing these functional aspects should be inferred from these descriptions unless explicitly stated or otherwise clear from the context. It will also be appreciated that the various steps identified and described above may be varied, and that the order of steps may be adapted to particular applications of the techniques disclosed herein. All such variations and modifications are intended to fall within the scope of this disclosure. The descriptions of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

As used herein, the following directional terms “front, back, above, downward, right, left, vertical, horizontal, below, transverse, row and column” as well as any other similar directional terms refer to those instructions of a device equipped with embodiments of the present invention. Accordingly, these terms, as utilized to describe embodiments of the present invention should be interpreted relative to a device equipped with embodiments of the present invention.

Each element for the system, device and apparatus described above can be implemented by hardware with or without software. In some cases, the system, device and apparatus may be implemented by one or more hardware processors and one or more software components wherein the one or more software components are to be executed by the one or more hardware processors to implement each element for the system, device and apparatus. In some other cases, the system, device and apparatus may be implemented by a system of circuits or circuitry configured to perform each operation of each element for the system, device and apparatus.

While the present disclosure includes many embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. An information processing system comprising:
a domain acquisitor configured to acquire a domain of a connection destination of a communication detected on a monitoring target network;
a related information acquisitor configured to acquire a related information from a domain management device, the related information being registered in association with the domain acquired by the domain acquisitor, the domain management device being configured to manage domains that are registered in the domain management device; and
an acquisitor configured to acquire, from the domain management device, a domain and a related information which is related to the domain, the related information acquired from the domain management device being identical at least in part to a related information which is related to a domain stored in a storage, the domain stored in the storage satisfying at least a condition.

2. The information processing system according to claim 1, further comprising:
a detector configured to determine the communication detected on the monitoring target network as a communication with a domain which satisfies the at least condition, in cases that the related information acquired by the acquisitor from the domain management device is not a related information related to the domain of the connection destination of the communication detected on the monitoring target network and that the related information acquired by the acquisitor from the domain management device is identical at least in part to the related information acquired by the related information acquisitor from the domain management device.

3. The information processing system according to claim 2, further comprising:
a registration unit configured to register information not stored in the storage among the related information acquired by the related information acquisitor in the storage as domain information satisfying the at least condition.

4. The information processing system according to claim 2, further comprising:
a domain information acquisitor configured to acquire domain information registered in association with the same information as at least one piece of the related information acquired by the related information acquisitor from the domain management device when the communication satisfies the at least condition; and
a domain information registration unit configured to register the domain information acquired by the domain information acquisitor in the storage as domain information satisfying the at least condition.

5. The information processing system according to claim 3, further comprising:
a domain information acquisitor configured to acquire domain information registered in association with the same information as at least one piece of the related information acquired by the related information acquisitor from the domain management device when the communication satisfies the at least condition; and
a domain information registration unit configured to register the domain information acquired by the domain information acquisitor in the storage as domain information satisfying the at least condition.

6. The information processing system according to claim 2, further comprising:
a receiver configured to receive a notification that information held by the domain management device has been updated; and
an additional domain registration unit configured to, when it is ascertained that a new domain has been added to the domain management device in association with the same information as at least one piece of the related information stored in the storage by the notification received by the receiver, register information on the added domain in the storage.

7. The information processing system according to claim 3, further comprising:
a receiver configured to receive a notification that information held by the domain management device has been updated; and
an additional domain registration unit configured to, when it is ascertained that a new domain has been added to the domain management device in association with the same information as at least one piece of the related information stored in the storage by the notification received by the receiver, register information on the added domain in the storage.

8. The information processing system according to claim 4, further comprising:
a receiver configured to receive a notification that information held by the domain management device has been updated; and
an additional domain registration unit configured to, when it is ascertained that a new domain has been added to the domain management device in association with the same information as at least one piece of the related information stored in the storage by the notification received by the receiver, register information on the added domain in the storage.

9. The information processing system according to claim 5, further comprising:
a receiver configured to receive a notification that information held by the domain management device has been updated; and
an additional domain registration unit configured to, when it is ascertained that a new domain has been added to the domain management device in association with the same information as at least one piece of the related information stored in the storage by the notification received by the receiver, register information on the added domain in the storage.

10. An information processing system comprising:
a storage that stores domains registered and satisfying at least a condition, and related information registered in association with the domains;
a domain information acquisitor configured to acquire, from a domain management device, domain information registered in association with a related information being identical at least in part to the related information stored in the storage, the domain management device being configured to manage domains registered; and
a registration unit configured to register, in the storage, the domain information acquired by the domain information acquisitor as domain information satisfying the at least condition.

11. The information processing system according to claim 10, wherein the registration unit is configured to register the domain information acquired by the domain information acquisitor as domain information satisfying the at least condition, regardless of whether or not the domain information is a domain information of a connection destination of a communication detected on a monitoring target network.

12. The information processing system according to claim 10,
wherein the domain information acquisitor further acquires information on another domain registered in association with the same information as at least one piece of the related information included in the domain information, registered in the storage by the registration unit, from the domain management device, and
the registration unit registers the information on the other domain acquired by the domain information acquisitor in the storage as information satisfying the at least condition.

13. The information processing system according to claim 10,
wherein the registration unit registers the domain information acquired by the domain information acquisitor by distinguishing the information from information already stored in the storage.

14. The information processing system according to claim 12,
wherein the registration unit registers the domain information acquired by the domain information acquisitor by distinguishing the information from information already stored in the storage.

15. An information processing method comprising:
acquiring a domain of a connection destination of a communication detected on a monitoring target network;
acquiring a related information from a domain management device, the related information being registered in association with the domain acquired, the domain management device being configured to manage domains that are registered in the domain management device; and
acquiring, from the domain management device, a domain and a related information which is related to the domain, the related information acquired from the domain management device being identical at least in part to a related information which is related to a domain stored in a storage, the domain stored in the storage satisfying at least a condition.

16. The information processing method according to claim 14, further comprising:
determining the communication detected on the monitoring target network as a communication with a domain which satisfies the at least condition, in cases that the related information acquired from the domain management device is not a related information related to the domain of the connection destination of the communication detected on the monitoring target network and that the related information acquired from the domain management device is identical at least in part to the related information acquired from the domain management device.

17. An information processing method comprising:
acquiring, from a domain management device, domain information registered and satisfying at least a condition in association with a related information being identical at least in part to the related information stored in the storage, the domain management device being configured to manage domains registered; and
registering, in the storage, the domain information acquired by the domain information acquisitor as domain information satisfying the at least condition.

18. A non-transitory computer-readable storage medium which stores a computer program, when executed by a computer, to cause the computer to perform at least:
acquiring a domain of a connection destination of a communication detected on a monitoring target network;
acquiring a related information from a domain management device, the related information being registered in association with the domain acquired, the domain management device being configured to manage domains that are registered in the domain management device; and
acquiring, from the domain management device, a domain and a related information which is related to the domain, the related information acquired from the domain management device being identical at least in part to a related information which is related to a domain stored in a storage, the domain stored in the storage satisfying at least a condition.

19. The non-transitory computer-readable storage medium according to claim 18, wherein the computer program is, when executed by the computer, to cause the computer to perform further at least:
determining the communication detected on the monitoring target network as a communication with a domain which satisfies the at least condition, in cases that the related information acquired from the domain management device is not a related information related to the domain of the connection destination of the communication detected on the monitoring target network and that the related information acquired from the domain management device is identical at least in part to the related information acquired from the domain management device.

20. A non-transitory computer-readable storage medium which stores a computer program, when executed by a computer, to cause the computer to perform at least:
acquiring, from a domain management device, domain information registered and satisfying at least a condition in association with a related information being identical at least in part to the related information stored in the storage, the domain management device being configured to manage domains registered; and
registering, in the storage, the domain information acquired by the domain information acquisitor as domain information satisfying the at least condition.
